(19) United States
(12) Patent Application Publication
(10) Pub. No.: US 2009/0322291 A1
(43) Pub. Date: Dec. 31, 2009

(54) Integrated circuit with output drive power section

(76) Inventors: Mike M. Ngo, Beaverton, OR (US); Steve Varnum, Tigard, OR (US); Shamala Chickamenahalli, Chandler, AZ (US); Nicholas Triantafillou, Portland, OR (US)

Correspondence Address: INTEL CORPORATION;c/o CPA Global, P.O. BOX 52050, MINNEAPOLIS, MN, 55402, US

(21) Appl. No.: 12/215,785

(22) Filed: Jun. 30, 2008

(51) Int. Cl. G05F 1/00

(52) U.S. Cl. 323/272

(57) ABSTRACT

In some embodiments, one or more configurably or selectably engageable power transistors are integrated into a chip comprising an output drive power module for a voltage regulator (VR). In some embodiments, a chip with an output drive power module may have a pulse width modulator (PWM) input that can accommodate both a single PWM drive signal and independent high side and low side PWM drive signals.

### BACKGROUND

The present invention relates generally to switching type voltage regulators and in particular, to an integrated circuit (IC) with one or more output sections.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a diagram of a voltage regulator (VR) output section in accordance with some embodiments.

FIG. 2 is a diagram of a portion of a VR with a VR output chip in accordance with some embodiments.

FIG. 3 is a layout diagram of the chip of FIG. 2 in accordance with some embodiments.

FIGS. 4A to 4C are signal diagrams showing drive signals for different conditions in accordance with some embodiments.

FIG. 5 is a block diagram of a computer system having a voltage regulator with an output section chip in accordance with some embodiments.

### DETAILED DESCRIPTION

In some embodiments, one or more configurably or selectably engageable power transistors are integrated into a chip comprising an output drive power module for a voltage regulator (VR). In some embodiments, a chip with an output drive power module may have a pulse width modulator (PWM) input that can accommodate both a single PWM drive signal and independent high side and low side PWM drive signals.

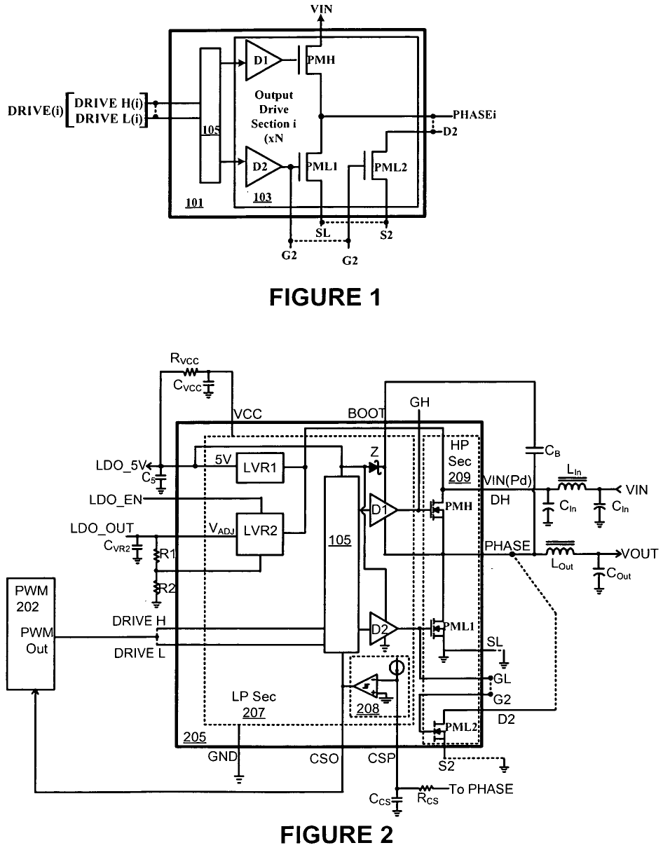

FIG. 1 shows a portion of a chip 101 with an output drive power module for providing a regulated DC output voltage. It has one or more drive power sections 103 and signaling 105 to couple PWM drive signals (DRIVE (i) for single input signal or DRIVE H(i) and DRIVE L(i) for independent high/low PWM signals) to the output drive power section(s) 103. (The chip has two inputs, DRIVE H(i) and DRIVE L(i), that can be tied together for each phase for a single input PWM signal implementation.) When in operation, the PWM signal(s) control the output drive power section(s) to generate an output phase signal (PHASEi). The output phase signal PHASEi is fed into off-chip components such as inductors and capacitors (not shown) to generate a regulated DC supply.

The output drive power module chip 101 may have one or more output drive power sections 103 for providing output PHASE i signals for single phase or multiple phase implementations. That is, in some embodiments, a single output drive power section may be in a chip, while in others, multiple output drive power sections may be in a chip. The depicted output drive power section 103 has a high-side power MOSFET (PMH), at least first and second low-side power MOSFETs (PML1, PML2), a high-side driver (D1) and a low-side driver (D2), all coupled as shown. The drivers (D1, D2) drive the high and low side power FETs in response to the drive signal(s) from the PWM to appropriately switch the FETs (e.g., in a Buck type push-pull manner) to generate a desired output signal (PHASEi), as is known in the art.

(The term “MOSFET,” or MOS transistor for short, refers to a metal oxide semiconductor field effect transistor. MOSFETs may be an N type “NMOS” or P-type “PMOS” and unless specifically referenced as a PMOS or NMOS, are not intended to be limited as such. In the depicted embodiment, N-type MOSFETs are used for both the low and high side power transistors, but this is not required. Moreover, unless otherwise expressly indicated or dictated by the nature of their use, reference to specific transistor types are used in an exemplary manner and should encompass the different varieties of MOS devices including devices with different threshold values, material types, insulator thicknesses, gate(s) configurations, to mention just a few. In addition, unless specifically referred to as MOS or the like, the term transistor can include other suitable transistor types, e.g., junction-field-effect transistors, bipolar junction transistors, metal semiconductor FETs, and various types of three dimensional transistors, MOS or otherwise, known today or not yet developed.)

The PWM (pulse width modulator) input, DRIVE(i), comprises two inputs, DRIVE H(i) and DRIVE L(i), to receive a PWM signal from a PWM controller (not shown). (Note, the number of DRIVE(i) signals will typically correspond to the number of phases used for the voltage regulator.) A dashed line is shown between the DRIVE H(i) and DRIVE L(i) inputs to indicate that they may be coupled together to facilitate a single drive input or kept separate for independent drive inputs. As discussed more below, this allows for the output drive power chip 101 to be used with PWMs having single drive outputs or independent high/low drive outputs. Independent high/low drive signals may be useful in that they allow for different operating modes, as will be discussed more below.

The second (or additional) low-side power MOS transistor (PML2) has its gate, drain, and source terminals decoupled (or configurable to be decoupled) from the first low-side MOS transistor. They are routed to chip output terminals G2, D2, and S2, respectively. This allows the second transistor PML2 to be coupled in parallel to the first low-side power MOS transistor, as is indicated with the dashed lines, or used separately for a different purpose.

This use of a second, selectably (or configurably) engageable, low-side power transistor increases flexibility in terms of doubling the current carrying capability of the low side power FET stage, thereby improving power density, or alternatively, the additional low-side FET could be used, for example, in combination with external components to operate as a pass transistor. For high power applications that require increased power capacity, the designer can parallel the pass transistor with the first integrated low-side FET to form a dual low-side FET stage that can double the current density of the low side FET stage, allowing support of higher power applications. On the other hand, for lower power applications, the designer can disengage, disconnect (or not connect in the first place) the connections between the source/drain/gate of the first and second low-side FETs to form a single low-side FET stage in the output section. In this configuration, the pass (additional or second) transistor is freed up and can be used as a general purpose FET or power management switch.

In some embodiments, the pass transistor PML2 and the first low-side FET should have power FET properties that substantially approach (if not equal) one another for increased efficiency and reliability. In addition, it may be observed that for increased current capability, an additional FET is available for the low-side switch but not necessarily for the high-side switch. This is due to the fact that in most applications, depending on load demands and design attributes, the high side FET will typically be turned on for less time than the low side FET(s), i.e., the high-side duty cycle will typically be significantly less than 50% (e.g., 10% to 40%) for most VR operating conditions. Therefore, the high-side transistor channels a lower average current than the low-side switch (one or more transistors), which means that its average-current capability may be smaller than that for the low-side switch for some applications.) It should also be appreciated that the dashed lines representing selectable (or configurable) connections between output terminals can be implemented in a variety of different ways. For example, they could be hard-wired such as during the manufacture of a motherboard, or alternatively, switches (e.g., transistors, relays, manual switches, etc.) could be used. They may be configurably engageable, which means that they can be engaged or disengaged while not in operation, i.e., during manufacture or re-work. Alternatively, they could be selectably engageable, meaning that they could be engaged or disengaged during chip or system operation.

FIG. 2 shows a diagram for more specific embodiments using a single phase output drive power section such as that shown in FIG. 1. (This chip embodiment could have additional phase sections for multi-phase implementations but a single phase example is used for simplicity.) In this diagram, external output supply components (L_{Out}, C_{Out}) and power input components (C_{In}, L_{In}), along with a PWM controller 202, are included, coupled as shown to an output drive power chip 205. Also included are external VCC filter components (R_{VCC}, C_{VCC}), an external boot capacitor (C_{B}), an external 5 V supply filter capacitor (C₅), an external variable supply adjustment filter capacitor (C_{VR2}), external adjustment resistors (R 1, R2), and external current sense components (R_{CS}, C_{CS}).

The chip 205 comprises a lower power section 207 and a higher power section 209. The lower power section 207 includes a 5V linear voltage regulator (LVR1), an adjustable linear voltage regulator (LVR2), drivers (D1, D2), diode (Z), and current sense circuit 208, coupled together as shown. The lower power section 207, including these components, comprises low power (e.g., operating in mA ranges from 1V to 5V) analog and digital components including lower power MOS transistors, while the higher power section 209 (which comprises the high and low side power transistors) comprises higher power devices such as MOSFETs capable of operating at up to 20V and handling average currents of up to five or more Amps. (Note that the output drive power section, which comprises the drivers and power FETs, occupies both the lower and higher power sections.)

With this embodiment, a 5V linear voltage regulator (LVR1) is included in the chip to provide a 5V supply for the chip itself, as well as to an external output (LDO_{—}5V), off of the input power supply (VIN), which may come from any suitable source such as a battery or AC adaptor. The adjustable supply is included to provide an additional external supply that is adjustable by selecting appropriate resistor values for R1 and R2. Similarly, an adjustable current sense is provided from the current sense circuit 208 by selecting an appropriate value for R_{CS}. The current sense signal (CSO) can be coupled to the utilized PWM 202 to serve as a feedback for VR control.

In some embodiments, the regulators (LVR1 and LVR2) may be implemented with low drop out (LDO) type regulators. Some PWMs 202 may use an LDO VR (such as LVR1 in this embodiment) to provide necessary boost current through a boot capacitor C_{B} to switch on an N-Channel high-side FET sufficiently hard. The additional programmable LVR2 is integrated to provide design flexibility and mother board area savings, as well as an optimal utilization of the available die area inside the chip 205, which in some embodiments, may be implemented with a multi chip package.

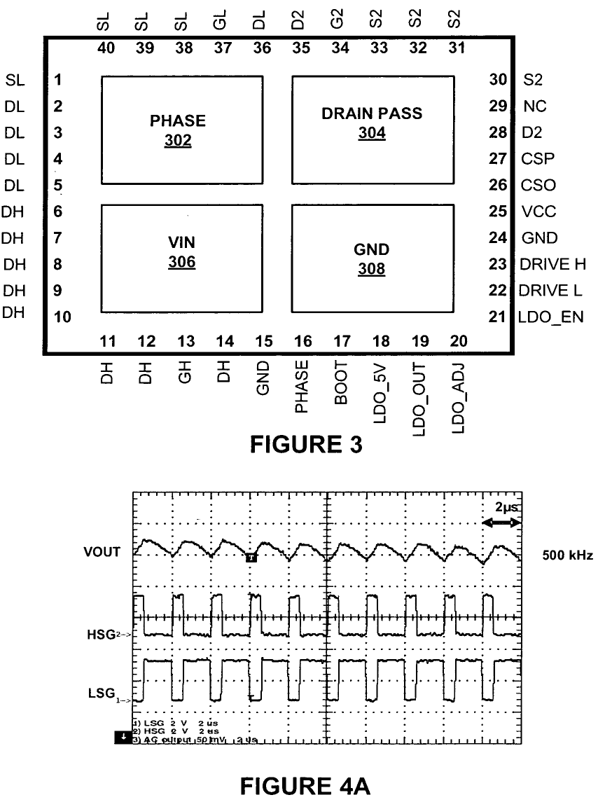

FIG. 3 is an exemplary layout diagram for chip 205 in accordance with some embodiments. Of note, areas 302, 304, 306, and 308 are depicted representing contact pad allocation for the PHASE, DRAIN PASS (D2), VIN, and GND signals respectively. This provides for higher current capacity for these signals.

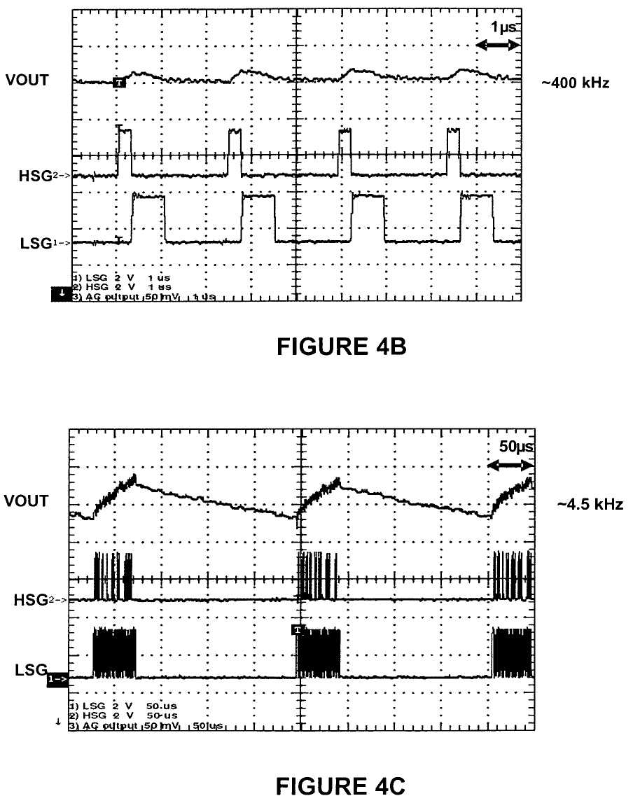

FIGS. 4A to 4C show different operating modes for a VR such as the VR of FIG. 2 when configured to operate with a PWM having independent high and low side drive signals. When the VR is under a heavy load, the PWM operates the switches (PMH, PML1/2) in a substantially continuous conduction mode (CCM), i.e., the output inductor is substantially continually charging or discharging. This is represented in FIG. 4A, which shows typical signals during a CCM. In this mode, the high and low side transistors are alternatively turned on. (Independent high/low drive signals are not necessarily exploited here.)

FIG. 4B shows operation in a discontinuous conduction mode (DCM) where the inductor has long stretches with no change in current. In this mode, the high and low side transistors may alternatively be on/off or they both may be off, as controlled by the high and low side drive signals.

FIG. 4C shows operation in a burst-mode with a variable, very low switching frequency. Here, the separate drive signals are also utilized.

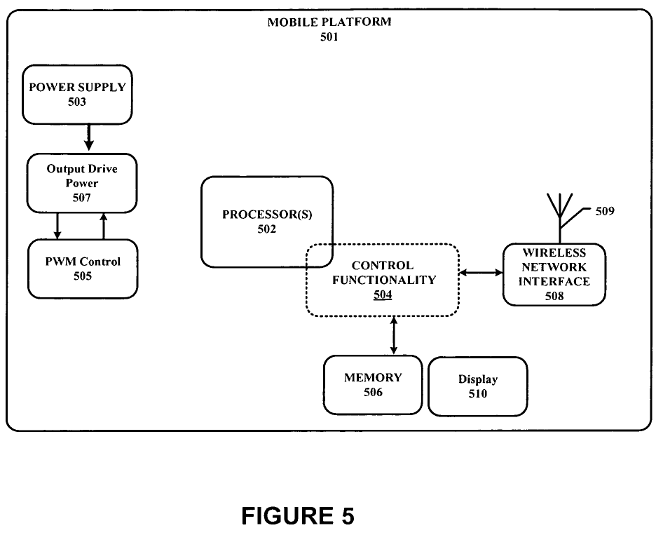

With reference to FIG. 5, one example of a portion of a computing platform 501 (e.g., computing system such as a mobile personal computer, PDA, cell phone, or the like) is shown. The represented portion comprises one or more processors 452, power supply 503, output drive power module 507, PWM control module 505, interface control functionality 504, memory 506, wireless network interface 508, antenna 509, and display 510. The power supply 503, which may include an AC adaptor pr a battery, is coupled to the output drive power module 507, which is coupled to the PWM control module 505, to provide one or more DC supplies to the platform components. The processor(s) 502 is coupled to the memory 506 and wireless network interface 508 through the control functionality 504. The control functionality may comprise one or more circuit blocks to perform various interface control functions (e.g., memory control, graphics control, I/O interface control, and the like. These circuits may be implemented on one or more separate chips and/or may be partially or wholly implemented within the processor(s) 502.

The memory 506 comprises one or more memory blocks to provide additional random access memory to the processor(s) 502. It may be implemented with any suitable memory including but not limited to dynamic random access memory, static random access memory, flash memory, or the like. The wireless network interface 508 is coupled to the antenna 509 to wirelessly couple the processor(s) 502 to a wireless network (not shown) such as a wireless local area network or a cellular network. The display 510 comprises one or more displays such as an LCD panel or the like to provide a visual interface to a user.

The computing platform 501 may implement a variety of different computing devices or other appliances with computing capability. Such devices include but are not limited to laptop computers, notebook computers, personal digital assistant devices (PDAs), cellular phones, audio and/or video media players, desktop computer, servers, and the like. It could constitute one or more complete computing systems or alternatively, it could constitute one or more components useful within a computing system.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like. It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An integrated circuit (IC) package, comprising:
a high-side power transistor;
a first low-side power transistor coupled to the high-side power transistor to facilitate a voltage regulator output;
a second low-side power transistor, and
external terminals to selectably or configurably engage the second low-side power transistor in parallel with the first low-side power transistor.

2. The IC of claim 1, in which the power transistors are N-type MOSFET transistors.

3. The IC of claim 1, further comprising a switch between gate terminals for the first and second low-side transistors.

4. The IC of claim 1, further comprising a linear voltage regulator to provide a voltage supply for circuitry in the IC package.

5. The IC of claim 1, comprising separate high and low side drive inputs.

6. The IC of claim 1, comprising additional high and low side power transistors to provide multiple output drive power sections for a multi-phase voltage regulator.

7. An integrated circuit (IC), comprising:
at least one output drive power section; and
independent high and low side drive inputs for driving the at least one output drive power section.

8. The integrated circuit of claim 7, in which the at least one output drive power section comprises a high-side power transistor, a first low-side power transistor coupled to the high-side power transistor to facilitate a voltage regulator output, a second low-side power transistor, wherein the second low-side power transistor is selectably or configurably engageable in parallel with the first low-side power transistor.

9. The IC of claim 8, in which the power transistors are N-type MOSFET transistors.

10. The IC of claim 8, further comprising a switch between gates for the first and second low-side transistors.

11. The IC of claim 8, further comprising a linear voltage regulator to provide a voltage supply for circuitry in the IC.

12. A computer system, comprising:
(a) a voltage regulator comprising a chip having:
a high-side power transistor,
a first low-side power transistor coupled to the high-side power transistor to facilitate a voltage regulator output,
a second low-side power transistor, and
external terminals to selectably or configurably engage the second low-side power transistor in parallel with the first low-side power transistor; and
(b) one or ore passive components coupled to the high and low side transistors to provide a regulated voltage supply.

13. The system of claim 12, comprising a power circuit external to the chip and coupled to it to incorporate the second low-side power transistor.

14. The system of claim 12, in which the power transistors are N-type MOSFET transistors.

15. The system of claim 12, further comprising a switch between gate terminals for the first and second low-side transistors.

16. The system of claim 12, further comprising a linear voltage regulator to provide a voltage supply for circuitry in the IC package.

17. The system of claim 12, wherein the chip comprises separate high and low side drive inputs.

18. The system of claim 12, comprising additional high and low side power transistors to provide multiple output drive power sections for a multi-phase voltage regulator.
